(19) United States
(12) Patent Application Publication
(10) Pub. No.: US 2017/0184187 A1
(43) Pub. Date: Jun. 29, 2017

(54) LINEAR ACTUATOR STRUCTURE

(71) Applicant: MOTECK ELECTRIC CORP., New Taipei City (TW)

(72) Inventor: Hsien-Te TSENG, New Taipei City (TW)

(21) Appl. No.: 15/297,483

(22) Filed: Oct. 19, 2016

(30) Foreign Application Priority Data
Dec. 24, 2015 (TW) 104143559

(51) Int. Cl. F16H 25/20

(52) U.S. Cl. CPC F16H 25/20; F16H 2025/204; F16H 2025/2031; F16H 2025/2084; F16H 2025/2081

(57) ABSTRACT

Disclosed is a linear actuator structure in which a seat body of a linear actuator body has a receiving space inside and a gear set is disposed in the receiving space, and a driving part is mounted with the seat body for driving rotation of the gear set, and the gear set is linked with a transmission mechanism having a lead screw, an extending outer tube is mounted with the seat body and has channel formed inside for insertion of the lead screw, the extending outer tube has the sliding groove axially recessed on the outer surface thereof and in communication with the channel. The lead screw is screwed with a joint member of the linking assembly which is axially linearly movable along the channel, and the joint member has a track plate extended from a central part and slidably located in and radially protruding out of the sliding groove.

This application claims the priority benefit of Taiwan patent application number 104143559, filed on Dec. 24, 2015.

### BACKGROUND OF THE INVENTION

1. Field of the Invention

The present disclosure relates to a linear actuator structure, more particularly to the linear actuator structure in which a lead screw is inserted into an extending outer tube of a linear actuator body, and a joint member is screwed with the lead screw and a track plate of the joint member is protruded out of a sliding groove of the extending outer tube, so as to achieve the effects of facilitating assembly and mass production, and improving the production efficiency.

2. Description of the Related Art

Currently, a linear actuator device is widely applied in many fields, and different types of linear actuator devices have different structure designs and transmission schemes, for example, the linear actuator devices can be applied in healthcare or home beds, massage chairs, fitness and rehabilitation equipment, door/window openers, or lift mechanism. During the motor power transmission of the general linear actuator device, a worm drives a worm wheel or a shaft drives a gear set to rotate a lead screw pushing a screw nut to axially linearly move, so as to drive a telescopic tube group to act simultaneously for adjusting the lifting height or rotation angle.

Furthermore, the traditional linear actuator device utilizes an outer tube of the telescopic tube group to limit a lateral movement of the screw nut acting with the telescopic tube simultaneously. The telescopic tube can be linearly extended or retracted along axis of the lead screw, and a fixed head of a front end of the telescopic tube drives movement of a working platform. The moving distance of the telescopic tube is an internal length of the of the outer tube subtracted by a length of the screw nut, so the working stroke of the linear actuator device is limited by the screw nut and the size of the linear actuator device cannot be reduced effectively. In order to increase the lifting distance of the linear actuator device, the length of the telescopic tube must be increased; however, if the telescopic tube is extended to exceed the housing of the linear actuator device by an excessive distance, the linear actuator device is easy to shake or become unstable. In addition, the telescopic tube is mounted between the screw nut and the fixed head by a manner of screwing, so that when the working platform is subjected to an excessive applied force or vibration by an external force for a long time, the telescopic tube may be coming loose.

In order to solve the problem of the telescopic tube group of the traditional linear actuator device in practical use, a manufacturer provides a linear actuator device in which a worm assembly is disposed in an iron track which is connected with a motor assembly. The motor assembly includes a shell member and an electric motor fixed inside the shell member. The worm assembly has a driving plate which crosses and connects to the iron track, and the driving plate has a connection base configured to movably connect with a linkage rod. An end of the iron track is connected with a shaping cover by a fastener, and the shaping cover is used to fix the worm assembly. The driving plate can cross and connect with the iron track to screw with the worm assembly, and the worm assembly has longer stroke distance while driving the driving plate to slide along the iron track. However, it is difficult to simplify the entire structure of the above-mentioned linear actuator structure because the driving plate must cross and connect with the iron track to screw with the worm assembly, even if during the assembly of the driving plate, the driving plate crosses and connects with the iron track first and then the worm assembly is screwed with the driving plate, or the worm assembly is screwed with the driving plate first and the iron track is then inserted through the driving plate and finally mounted on the shell member of the motor assembly. As a result, the entire structure of above-mentioned linear actuator structure is complicated and it spends more time in alignment between components during assembly, and which results in complicated manufacturing and assembly process and unfavorable in mass production. What is need is a new linear actuator structure without the above-mentioned problems.

### SUMMARY OF THE INVENTION

In order to solve the above-mentioned problem, the inventor collects associated data for evaluation, and finally develops a linear actuator structure according to research experience and multiple tests.

A primary objective of the present disclosure is to provide a linear actuator body. In the linear actuator body, a seat body has a receiving space inside and a gear set is disposed in the receiving space, and a driving part is mounted with the exterior of the seat body and operative to drive rotation of the gear set, and the gear set is linked with the transmission mechanism having a lead screw. An extending outer tube is mounted with a front part of the seat body and has a channel formed inside for insertion of the lead screw, the extending outer tube has the sliding groove axially recessed on the outer surface thereof and in communication with the channel Furthermore, the lead screw is screwed with a joint member of the linking assembly which is axially linearly movable along the channel, and the joint member has a track plate extended from a central part thereof and slidably located in and radially protruded out of the sliding groove. By the structural design in which the track plate of the joint member is in cooperation with the single sliding groove of the extending outer tube, the entire linear actuator structure can be simplified and its manufacturing and assembly process can become simpler, so that the effects of facilitating assembly and mass production, improving the production efficiency and reducing manufacturing cost can be achieved.

A secondary objective of the present disclosure is that when the driving part drives the driving shaft to rotate the gear set, the lead screw is driven to rotate simultaneously and further push the joint member of the linking assembly, so that the track plate of the joint member is axially linearly slid along the sliding groove of the extending outer tube. Therefore, the plurality of protrusion tracks of the extending outer tube and the track slot of the joint member are slid relatively to form guiding and position-limiting effects. Each of the plurality of protrusion tracks and the track slot can be formed integrally by metal or plastic material with low friction coefficient, so that the contact between the joint member and the extending outer tube can have the property of self-lubricating, thereby assisting the joint member to slide more stably and smoothly.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is an oblique top elevational view of a preferred embodiment of a linear actuator structure of the present disclosure.

FIG. 2 is a perspective exploded view of the preferred embodiment of the linear actuator structure of the present disclosure.

FIG. 3 is a perspective exploded view of the preferred embodiment of the linear actuator structure of the present disclosure, when viewed from another angle.

FIG. 4 is a cross section view taken along line A-A of FIG. 1 of the present disclosure.

FIG. 5 is a cross section view taken along line B-B of FIG. 1 of the present disclosure.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

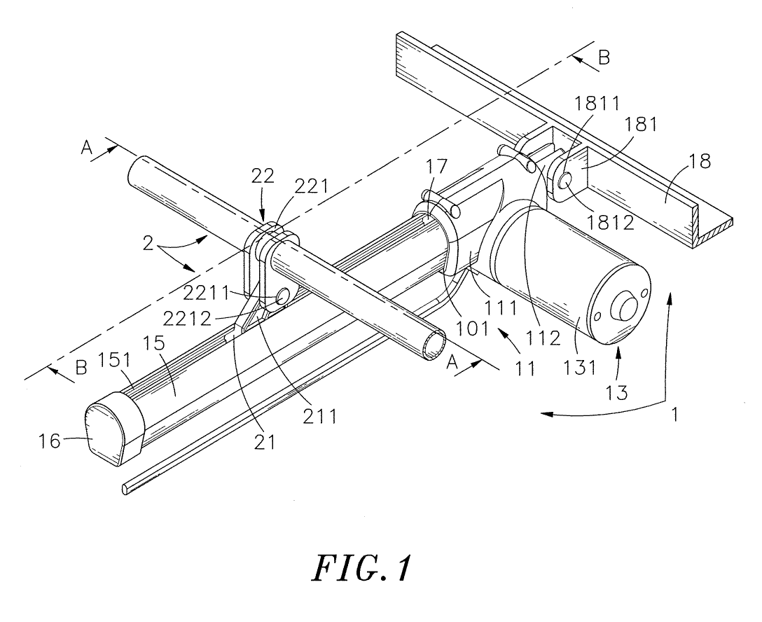

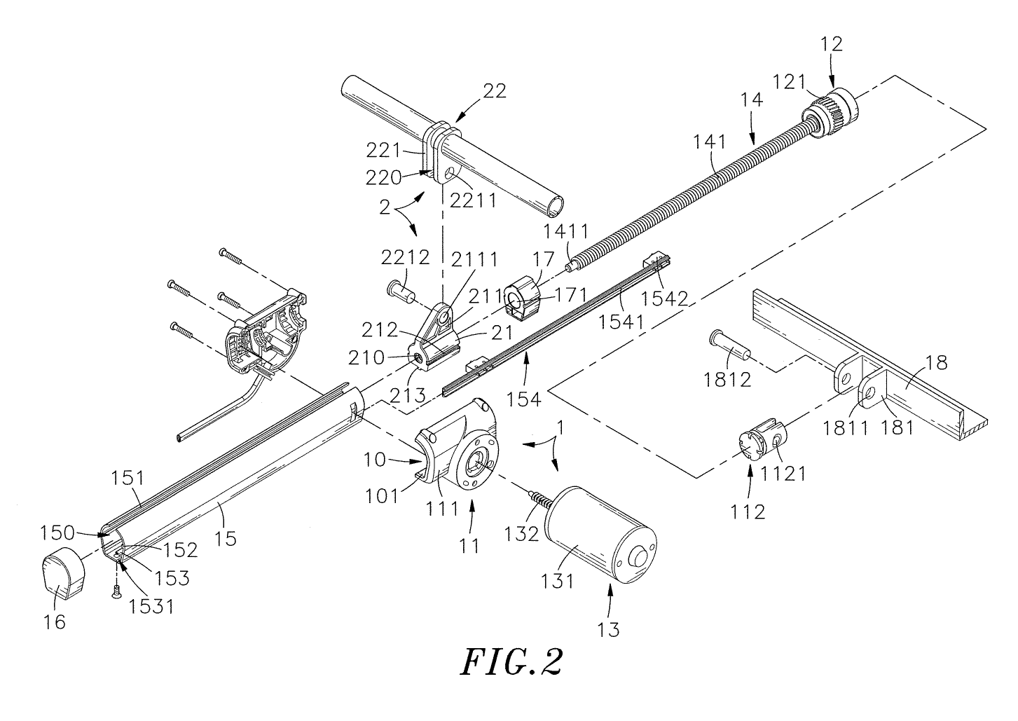

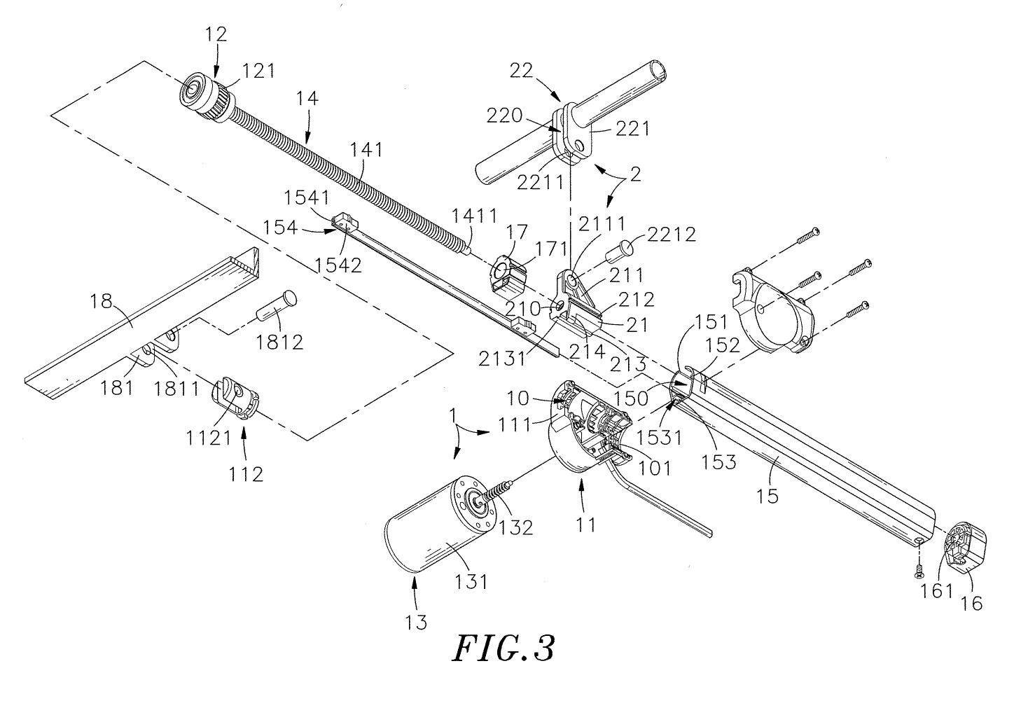

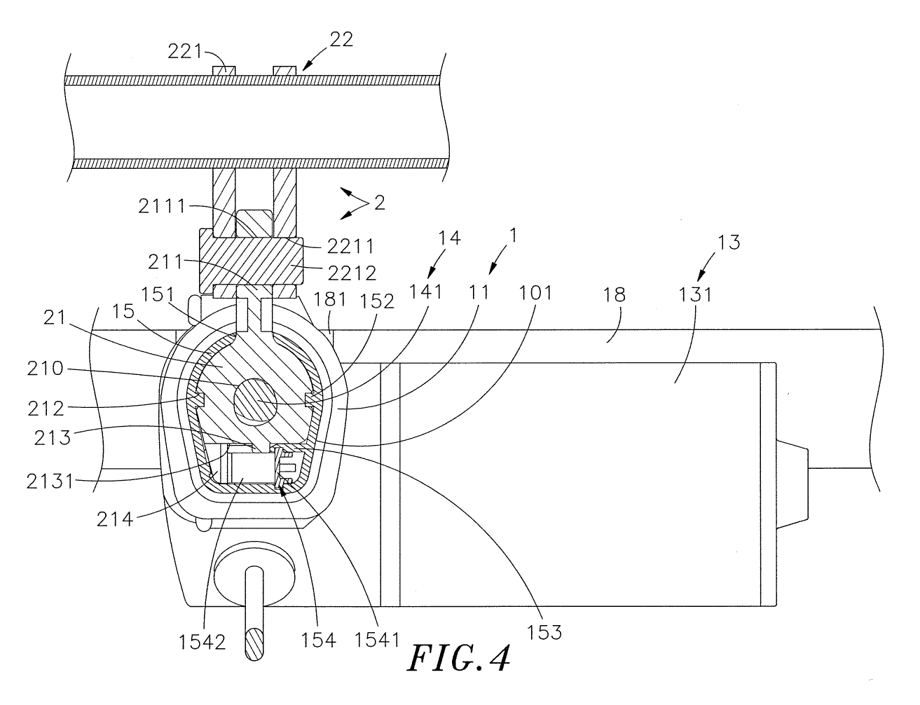

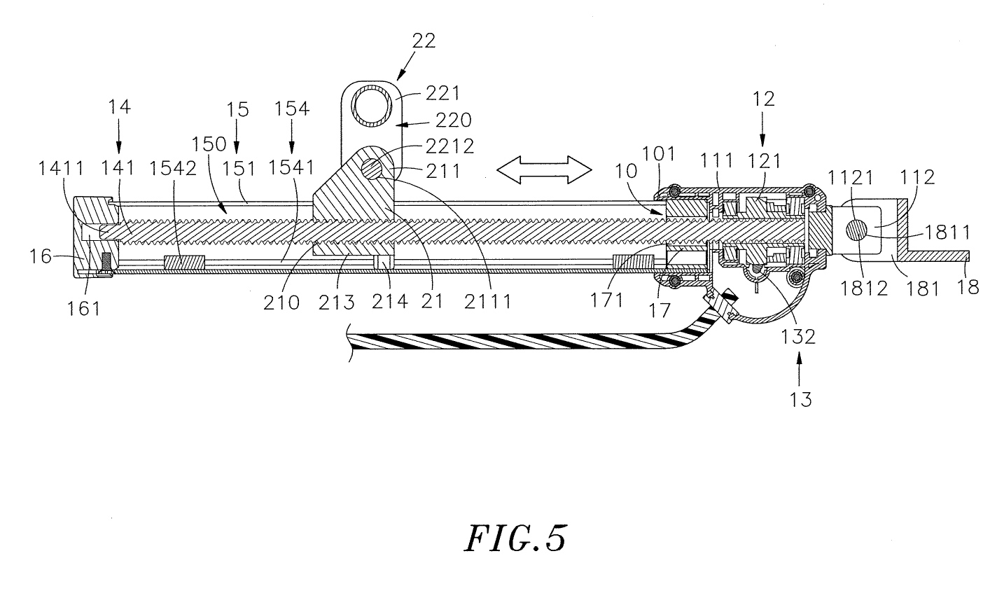

Please refer to FIGS. 1-5 which respectively show the oblique top elevational view, the perspective exploded view, the perspective exploded view when viewed from another angle, the cross section view taken along line A-A of FIG. 1, and the cross section view taken along line B-B of FIG. 1, of the preferred embodiment of the present disclosure. A linear actuator structure of the present disclosure includes a linear actuator body 1 and a linking assembly 2.

The linear actuator body 1 has a seat body 11 with a hollow part, and the seat body 11 inside defines a receiving space 10 which has openings 101 at front and rear sides thereof. A connection base 112 is fastened with two outer shell members 111 of the seat body 11 through the openings 101 of the rear side of the receiving space 10. The connection base 112 has a first mounting hole 1121. At least one driving gear 121 (such as a worm wheel or a spur gear) of a gear set 12 is disposed inside the receiving space 10 of the seat body 11. A driving part 13 is mounted on the exterior of the seat body 11, and has a driving shaft 132 (such as a worm or a spur gear mounted on a shaft) disposed a side thereof where a motor 131 is disposed. The driving shaft 132 is inserted into the receiving space 10 to engage with the driving gear 121, so as to drive rotation of the driving gear 121. The gear set 12 is linked with a transmission mechanism 14 having a lead screw 141, and the lead screw 141 and the motor 131 are perpendicular or parallel to each other.

Furthermore, an extending outer tube 15 is fastened with the outer shell members 111 of the seat body 11 through the opening 101 of the front side of the seat body 11, and is extended out of the seat body 11. Preferably, the extending outer tube 15 is formed integrally by aluminum extrusions; however, in actual application, the extending outer tube 15 can also be fanned integrally by metal stretching process. The extending outer tube 15 has a channel 150 formed inside for insertion of the lead screw 141 which is at a suspending status inside the channel 150. The extending outer tube 15 further has a sliding groove 151 formed at a central part of a top surface thereof and extended between end surfaces of two sides thereof. The sliding groove 151 is in communication with the channel 150. The extending outer tube 15 has a plurality of protrusion tracks 152 disposed in parallel on an inside wall of the channel 150 and protruded inwardly. A stop plate 153 is horizontally and axially disposed under the protrusion tracks 152, and a mounting slot 1531 is formed between the stop plate 153 and the bottom side of the extending outer tube 15. A switch assembly 154, which has a positioning plate 1541, is perpendicularly fastened in the mounting slot 1531, and limit switches 1542 are respectively disposed at front and rear sides of the surface of the positioning plate 1541.

A cover 16 and a fixing base 17 are respectively mounted with the extending outer tube 15 through the openings of the front and rear sides of the channel 150, and the fixing base 17 is disposed inside the seat body 11. The cover 16 has an axle hole 161, and an end portion 1411 extended from a front part of the lead screw 141 is inserted into the axle hole 161 for forming movable pivotal connection. The fixing base 17 has a through hole 171 and the lead screw 141 is passed through the through hole 171 to extend out of the seat body 11. The connection base 112 of the seat body 11 is used to connect with a bracket seat 18 of an external device (such as an electric bed, a massage chair, fitness and rehabilitation equipment), a lift mechanism, or other equipment. The bracket seat 18 has two retaining plates 181 corresponding in position to each other, and each of the two retaining plates 181 has a second mounting hole 1811 for insertion of a bolt or a pin 1812. Therefore, the pin 1812 can be inserted through the second mounting holes 1811 of the retaining plates 181 and the first mounting hole 1121 of the connection base 112, so as to form movably pivotal connection.

The linking assembly 2 includes a joint member 21 disposed in the channel 150 of the extending outer tube 15, and a link rod 22 linked with the joint member 21. The joint member 21 has an internal chamber formed with a thread hole 210 which can be in screw-connection with the lead screw 141. The joint member 21 further has a fin-shaped track plate 211 extended outwardly from a central part thereof, radially protruded out of the sliding groove 151 and slidable located in the sliding groove 151. The track plate 211 has a first connection hole 2111 formed at an upper part thereof, and the joint member 21 has a plurality of track slots 212 recessed on two opposite side surfaces and configured to slide along the protrusion tracks 152 of the extending outer tube 15. The track slots 212 and the track plate 211 are perpendicular to each other. The joint member 21 has a positioning slider 213 disposed at an approximately central part of a bottom side thereof and configured to abut with and slide along the lateral of the stop plate 153. The positioning slider 213 has a step-like supporting surface 2131 formed at a lateral surface thereof adjacent to the joint member 21 and configured to abut with the stop plate 153. The joint member 21 further has a cantilever pushing block 214 extended downwardly form the bottom side thereof and configured to push and trigger one of the limit switches 1542 of the switch assembly 154.

In addition, the link rod 22 has joint plates 221 corresponding in position to each other and perpendicular to the link rod 22. A mounting space 220 is formed between the two joint plates 221, and the track plate 211 is mounted in the mounting space 220. A positioning member 2212 (such as the bolt or the pin) is inserted through second connection holes 2211 of the two joint plates 221, so that the positioning member 2212 can be inserted through the second connection holes 2211 of the joint plates 221 and the first connection hole 2111 of the track plate 211, so as to form movable pivotal connection.

The connection base 112 and the track plate 211 of the linking assembly 2 of the linear actuator body 1 of the present disclosure are respectively linked with the bracket seat 18 and the link rod 22 of the external device. When the motor 131 of the driving part 13 drives the driving shaft 132 to rotate the gear set 12, the driving gear 121 of the gear set 12 drives the lead screw 141 to rotate simultaneously, and the lead screw 141 is rotated to push the joint member 21 of the linking assembly 2, so that the track plate 211 of the joint member 21 is axially linearly slidable along the sliding groove 151 of the extending outer tube 15. Therefore, the plurality of protrusion tracks 152 of the extending outer tube 15 and the track slot 212 of the joint member 21 are slid relatively to form guiding and position-limiting effects. Each of the plurality of protrusion tracks 152 and the track slot 212 can be formed integrally by metal or plastic material with low friction coefficient, so that the contact between the joint member 21 and the extending outer tube 15 has the property of self-lubricating, thereby assisting the joint member 21 to slide more stably and smoothly and prevent from component damage or noise problem caused by contact friction for long time under a condition of the high friction coefficient. Furthermore, simultaneous action of the track plate 211 of the joint member 21 and the joint plate 221 enables the axial linear movement or rotation of the link rod 22. By the structural design in which the track plate 211 of the joint member 21 is in cooperation with the single sliding groove 151 of the extending outer tube 15, the entire linear actuator structure can be simplified and its manufacturing and assembly process can become simpler, so that the effects of facilitating assembly and mass production, improving the production efficiency and reducing manufacturing cost can be achieved.

While the lead screw 141 drives the joint member 21 of the linking assembly 2 to move forwardly, the limit switch 1542 of the switch assembly 154 located at a destination position can be triggered by the pushing block 214, and the motor 131 is controlled, by switching of the limit switch 1542, to drive the gear set 12 to counter-rotate the lead screw 141, so that the joint member 21 is driven to reversely move to return to a starting position. When the pushing block 214 of the joint member 21 triggers the limit switch 1542 at the starting position, the motor 131 is controlled to drive the gear set 12, to enable the lead screw 141 to drive the joint member 21 to move forwardly or stop moving. According to above-mentioned operations, the linear actuator body 1 can be controlled to perform or change the stroke of linear reciprocation.

Therefore, a primary objective of the present disclosure is to provide the linear actuator body 1. In the linear actuator body 1, the seat body 11 has the gear set 12 disposed inside, and the driving part 13 is mounted with the exterior of the seat body 11 and operative to drive the rotation of the gear set 12, and the gear set 12 is linked with the transmission mechanism 14 having the lead screw 141, the extending outer tube 15 is mounted with the front part of the seat body 11 and has the channel 150 formed inside for insertion of the lead screw 141, the extending outer tube 15 has the sliding groove 151 axially recessed on the outer surface thereof and in communication with the channel 150, the lead screw 141 is screwed with the joint member 21 of the linking assembly 2 which is axially linearly movable along the channel 150, and the joint member 21 has the track plate 211 extended from the central part thereof and slidably located in and radially protruding out of the sliding groove 151. By the structural design in which the track plate 211 of the joint member 21 is in cooperation with the single sliding groove 151 of the extending outer tube 15, the entire linear actuator structure can be simplified and its manufacturing and assembly process can become simpler, so that the effects of facilitating assembly and mass production, improving the production efficiency and reducing manufacturing cost can be achieved.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A linear actuator structure comprising a linear actuator body and a linking assembly, wherein:
said linear actuator body comprises a seat body having receiving space inside, a gear set disposed in the receiving space, a driving part mounted with the exterior of said seat body and operative to drive rotation of said gear set, said gear set linked with a transmission mechanism having a lead screw, an extending outer tube mounted with a front part of said seat body and having a channel formed inside for insertion of said lead screw, and the extending outer tube has a sliding groove axially recessed on an outer surface thereof and in communication with said channel; and
wherein said linking assembly comprises a joint member disposed in said channel of said extending outer tube, and said joint member has a thread hole screwed with said lead screw to enable said lead screw to rotate and push said joint member to axially linearly move, and has a track plate extended from a central part thereof and slidably located in and radially protruding out of said sliding groove.

2. The linear actuator structure according to claim 1, wherein said seat body of said linear actuator body has openings formed at front and rear sides of said receiving space thereof, and said extending outer tube is mounted with two outer shell members of said seat body through said opening at the front side, and said extending outer tube has said sliding groove axially recessed at a central part of a top surface thereof and extended between end surfaces of two opposite sides thereof,

3. The linear actuator structure according to claim 2, wherein a connection base is mounted with said two outer shell members of said seat body through said opening at the rear side of said receiving space of said seat body, and said connection base has a first mounting hole and is mounted on a bracket seat of an external device, and said bracket seat has two retaining plates corresponding in position to each other, a pin is inserted through a second mounting holes of two retaining plates and said first mounting hole to form movably pivotal connection.

4. The linear actuator structure according to claim 1, wherein said gear set of said linear actuator body has at least one driving gear, and said driving part has a motor and a driving shaft disposed at a side thereof where said motor is located, and said driving shaft is inserted into said seat body to engage with said at least one driving gear, and said lead screw and said motor are perpendicular or parallel to each other.

5. The linear actuator structure according to claim 1, wherein said extending outer tube of said linear actuator body has a plurality of protrusion tracks disposed at an inside wall of said channel thereof, and said joint member of said linking assembly has a plurality of track slots recessed on an outer surface thereof and slidable along said plurality of protrusion tracks.

6. The linear actuator structure according to claim 5, wherein said channel of said extending outer tube is formed with a stop plate axially horizontally disposed under said plurality of protrusion tracks, and a positioning plate of a switch assembly is perpendicularly mounted in a mounting slot formed between said stop plate and a bottom side of said extending outer tube, two limit switches are respectively disposed at front and rear sides of a surface of said positioning plate, and said joint member has a positioning slider disposed at a bottom side of said joint member and operative to abut with and slide along said stop plate, and said joint member has a pushing block downwardly extended from the bottom side thereof and configured to push and trigger one of said two limit switches.

7. The linear actuator structure according to claim 1, wherein said extending outer tube of said linear actuator body is respectively mounted with a cover and a fixing base through said openings of the front and rear sides of said channel, and said cover has an axle hole for insertion of said lead screw to form movably pivotal connection, and said fixing base has a through hole and said lead screw is inserted through and extended out of said seat body.

8. The linear actuator structure according to claim 1, wherein said linking assembly has a first connection hole formed at an upper portion of said track plate of said joint member, and a link rod of an external device is mounted with said joint member, and said link rod has two joint plates corresponding in position to each other, and a positioning member is inserted through second connection holes of said two joint plates and said first connection hole to form movably pivotal connection.
